(19) United States
(12) Patent Application Publication
(10) Pub. No.: US 2009/0077556 A1
(43) Pub. Date: Mar. 19, 2009

(54) IMAGE MEDIA MODIFIER

(76) Inventor: Martin Kay Nohr, Medicine Hat (CA)

Correspondence Address: Leffert Jay & Polglaze, P.A., P.O. Box 581009, Minneapolis, MN, 55458-1009, US

(21) Appl. No.: 11/857,766

(22) Filed: Sep. 19, 2007

(51) Int. Cl. G06F 9/46

(52) U.S. Cl. 718/101; 718/100

(57) ABSTRACT

A method and apparatus for back-end processing a recordable media production job after it has been generated and sent to a recordable media production system is described that intercepts the image file generation at a low level within the recordable media production system and allows for adding, deletion and modification of the underlying data files and/or modification of the production job itself under control of an external user defined process, such as an application, DLL, script or plug-in. This interception of the image file generation occurs before the final image is assembled and handed off to the media recorder/producer to be written to the recordable media and is invoked at multiple stages of reading the production job edit list, allowing changes to occur at each stage of the imaging or pre-mastering (file system creation) process.

### FIELD

The present invention relates generally to image assembly and recording on media and in particular the present invention relates to back-end processing of image files before recording on to final media.

### BACKGROUND

Storage capacity for computer and electronic readable media continues to increase at rapid rates. Just a few years ago, removable media such as floppy disks were limited to 1.44 Megabytes. Now, recordable media such as DVD and dual layer DVD allow storage of upwards of 9 Gigabytes (GB), and newer technology such as Blu-Ray DVDs allow storage of 54 GB to 108 GB, or higher. Increasing along with recordable media sizes is the large and varied usage recordable media is being put to and legacy systems now being expected to utilize new media types and need for recording on and copying of such.

In recording on or writing recordable media, a project or imaging job to be recorded or “produced” is generated either locally or at a remote computer by client software or other source into a production or imaging job to be sent to a recordable media production system or server. The imaging job is then handed off to the production system where the files and directories of the imaging job are assembled (optionally by being cached locally) and formatted into an image file, also known as a pre-mastered file or track file, before it is written to the selected recordable media by the recordable media producer/recorder. Alternately, a final image file, such as a pre-mastered file or track file, requiring minimal processing or assembly can be sent directly to the production system for writing to the recordable media.

An issue with prior art production systems are that modifications or alternative handling of the image and the underlying component files or file system of an imaging job are often desired, but are difficult or impossible to accomplish after the imaging job has been completed and sent to the production system by the client software or source. Another issue with prior art recordable media production systems is that in many cases, in particular with legacy systems, the client software or source application cannot be easily modified to make the desired changes due to complexity, software issues, or unavailability of the source code.

For the reasons stated above, and for other reasons stated below which will become apparent to those skilled in the art upon reading and understanding the present specification, there is a need in the art for improved recordable media imaging job handling and modification in media production systems.

### BRIEF DESCRIPTION OF DRAWINGS

FIG. 1 is a prior art media production system.

FIG. 2A is a media production system according to an embodiment of the invention.

FIG. 2B is a simplified flow chart of transactions between an imager/producer and client according to an embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and software or electrical changes may be made without departing from the scope of the present invention. The following detailed description is, therefore, not to be taken in a limiting sense, and the scope of the present invention is defined only by the appended claims, along with the full scope of equivalents to which such claims are entitled.

As stated above, in writing to recordable media, a production/image job or a final image file is written by a recordable media production system onto the media. The project or imaging job to be recorded or “produced” in the production system or server is generated either locally or at a remote computer by client software or other source into a production or imaging job. The imaging job is then handed off to the production system where the files and directories of the imaging job are assembled (often being read into the production system and cached locally) and formatted into an image file by an imaging or pre-mastering server before it is written to the selected recordable media by the recordable media producer or recorder (such as a CD-ROM or DVD burner). The final image file is also known as a pre-mastered file or track file. Alternately, a final image file, such as a pre-mastered file or track file, requiring no further assembly can be sent directly to the production system for writing to the recordable media. It is also noted that “recordable media” is defined herein to include recordable media of a fixed size that can be written by a production system, including magnetic media (such as, but not limited to, floppy disks, magnetic tapes and hard drive disks), optical media (such as, but not limited to, CD-ROMs, DVDs, Blue-Ray DVDs, Magneto-Optical (MO) disc, and Holographic), and solid-state media (such as, but not limited to, Flash memory devices and PROM memory devices).

Production jobs or image jobs that are sent from the client software to the recordable media production systems for processing are typically lists of files and supplemental information that define the format or file system of the job, directory structure, files (typically including file name, size, dates (such as creation, last access, and modification) source and destination within the directory structure) and other supplemental information (such as, but not limited to configuration files, menus, disk labels, archive data, and serial number or IDs). Common file systems and formats for image files and their corresponding media include, but are not limited to, FAT16, FAT24, FAT32, NTFS, ISO 9660, UDF, HFS, HFS+, Joliet, Rockridge, and UFS.

These lists of files for the production are typically referred to as an image plan or “edit list” and define form and content of the production job. Alternatively, the production job can be a production directory (also referred to as a parent folder) containing the required information for the job. This information is then utilized by the imager in the production system to assemble the final image file for writing by the producer to the selected media.

As stated above, image files that are utilized by the producer to write the recordable media are also known as pre-mastered files or track files. As used herein, image files are defined to be the final media data image that can be directly written to the selected media with little or no processing by the production system. Image files contain the assembled file system, directories and files that are to be written onto the media by the producer of the production system and can be in a track-by-track format for the specified media type. Image files may also contain more than one file system. As noted above, image files can be directly sent to and utilized by the production system, but are typically assembled internally in the production system by an imager application in a process called imaging or pre-mastering before being sent to the producer for writing. There are many formats possible for the image file, they can be raw (track image), or they may be compressed or augmented in various ways. One such proprietary image format, known as PowerImage, is owned by the assignee to the present application. PowerImage is a compressed format that removes the file contents for later insertion during recording or production, reducing the size of the image file.

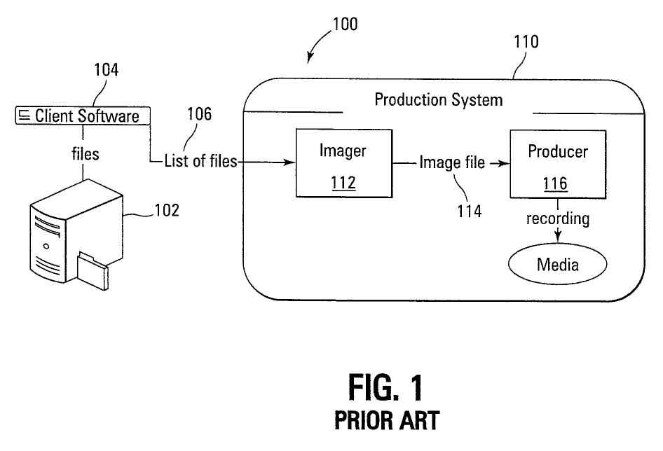

FIG. 1 details a simplified block diagram of a prior art production system and client. In FIG. 1, a system 100 incorporates a client computer 102 with a client application 104 that is coupled to a production system 110. The client software 104 on the client computer 102 generates a production job and transfers the edit list/list of files 106 of the job to the production system 110 to be written to recordable media. Within the production system 110 the edit list 106 is processed and assembled into an image file 114 by an imager 112. During this imaging or pre-mastering process, the imager 112 reads the edit list 106 line by line, creating the specified file system format and directory structure of the image file 114. If the PowerImage format is not used, the imager 112 then also reads each of the files listed in the edit list 106 from the specified source and populates it into the image file 114 in the appropriate destination location within the file system/directory structure created for the production job. In addition, supplemental information and instructions in the edit list 106 can be read and acted upon by the imager 112, modifying files and creating and populating configuration files, menus, disk labels, etc. in the image file 114. Once the image file is created from the edit list and the source files read in and populated, the image file 114 is transferred to a producer 116, which then writes it to the selected recordable media. At this stage, if the image file is a PowerImage format, the file contents are inserted by the producer 116 during the writing process. It is noted that the imager 112 and the producer 116 do not have to reside on the same physical computer but may be distributed on a network. In addition, it is noted that there may be one or more imagers 112 and one or more producers 116 in the production system 110.

In the prior art system 100 of FIG. 1, once the production job edit list 106 is transferred to the production system 110 the production job is frozen and cannot be modified during processing by the production system 110. As noted above, it is often desired to modify or further process files of the production job after it has been handed off to the production system 110. In particular, this need for back-end processing of the content or files of the production job can arise in cases where the client software cannot be easily modified to make the desired changes directly to the production job or its generated edit list, such as with complex software, legacy systems, unavailable client source code, or changed media types.

Embodiments of the present invention allow for modification or back-end processing (also known as post-imaging or pre-recording processing) of a recordable media production job after it has been handed off to the production system. This is done by intercepting the edit list at a low level in the production system before the final image file is sent to the producer to be written to the media. This allows a call to a user defined process, such as an application, a dynamically linked library (DLL), a script, a batch file or a plug-in, to occur which can then processes the edit list or underlying files as desired at specified points in the imaging or pre-mastering process.

Such post-production processing or modification of the production job can include, but is not limited to, encryption, watermarking, compression, adding or deleting files or directories to or from the edit list, changing file or directory names, appending to files, adding or changing archive data, adding/changing media sourcing or specified recipient tracking data, adding different menus, sub-versioning the production job, and adding a serial number or ID. It is noted that such interception and modification of the edit list and underlying files occurs transparently for the client software that generated the original production job, which has no knowledge that the production job was changed and can, itself, remain unmodified.

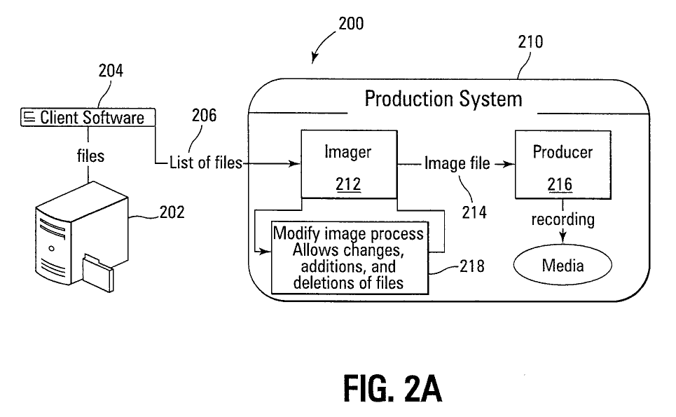

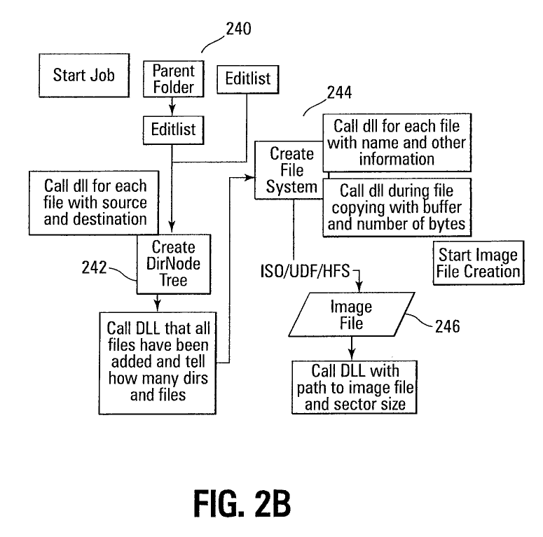

FIG. 2A details a simplified block diagram of a system 200 incorporating a production system 210 of an embodiment of the present invention. In FIG. 2A, a system 200 according to one embodiment of the invention is shown incorporating a client computer 202 having a client application 204 coupled to a production server or system 210. It is noted that the production system 210 is typically a remote computer coupled the client computer 202 through a network, but can also be resident on the client computer 202 itself. The client software 204 on the client computer 202 generates a production job and transfers the edit list or list of files 206 to the production system 210 to be written to recordable media. Within the production system 210 the edit list 206 is processed and assembled into an image file 214 by an imager 212 in an imaging or pre-mastering process. Once the image file is created from the edit list and the source files read in and populated, the image file 214 is transferred to the producer 216, which then writes it to the selected recordable media.

During the imaging or pre-mastering process, the imager 212 reads the edit list 206 line by line to process it into a final image file; creating the specified file system and directory structure of the image file 214, reading each of the files listed in the edit list 206 from the specified source and populating them into the image file 214 in the appropriate destination, and reading the supplemental information and instructions and acting upon them, creating and populating configuration files, menus, disk labels, etc. in the image file 214. In this, the imager 212 or production system 210 also invokes an external user defined process 218 such as an application, a dynamically linked library (DLL), a script, a batch file or a plug-in at selected points in the imaging or pre-mastering process. The external user process 218 can then add, modify, change or delete files and structures being processed from the edit list into final image file or the final image file itself. In embodiments of the present invention, typically only the item that the imager 212 is currently processing from the edit list can be changed to aid in avoiding issues with corruption, however, it is noted that any aspect of the production job, edit list, underlying files, file system, directory structure, supplemental information and/or final image file can be added to, modified and/or deleted by the external user defined process 218 while being back-end processed by the production system 210. Because of this calling of the external user defined process 218, in the system 200 of FIG. 2A, the production job is not frozen once the production job edit list 206 is transferred to the production system 210 from the client 204 and can be modified during processing by the production server 210.

In one embodiment of the present invention, the context of the imaging or pre-mastering process from the imager 212 or production system 210 is passed to the external user defined process 218. Such context can include, but is not limited to, the production job edit list name and location, the edit list line being processed, the file name, file size, file source and file destination directory being currently processed. In another embodiment of the present invention, the imager 212 and the pre-mastering process is suspended during the call to the external user process 218 to avoid corruption of the final image and/or underlying files of the production job. Once the external user defined process 218 finishes its execution and returns, the imager 212 simply resumes the pre-mastering process or, if directed, deletes the file currently being processed, as such, modifications are transparent to the imager 212.

In further embodiment of the present invention, the imager 212 searches for an external user defined process, application, dynamically linked library (DLL), script, batch file or plug-in that has either a statically assigned name or has been passed into the production system 210 or imager 212 through a passed in argument or configuration file listing. In one embodiment, if the static external user defined process 218 does not exist or is not passed in or defined in the configuration files, the production system 210 does not invoke the external user defined process 218. In addition, it is noted that in another embodiment of the present invention the external user defined process can be a shell or stub process that invokes multiple sub processes, or the imager 212 or production system 210 can invoke multiple user defined processes 218 directly that are sequentially executed in turn if they are passed in or defined in a production system 210 configuration file.

FIG. 2B details a simplified flowchart of the pre-mastering process of an embodiment of the present invention, detailing possible invocation points for the external user defined process 218. It is noted that this listing of possible external user defined process 218 invocation points in the pre-mastering process of FIG. 2B is for illustration purposes only and should not be taken as limiting. In FIG. 2B, the production job is handed off to the production system 210 and the imager 212 starts processing by reading in the production job edit list or parent directory 240. The directory structure specified in the edit list is created and files are read in from their sources and placed in the specified destinations in the directory structure 242. The file system containing the directory, files and supplemental information from the edit list in the specified format is then created 244 and the directory structure and files written to it and the final image file created 244. During this pre-mastering process the external user defined process 218 can be invoked at each line of the edit list and for different major stages of the process. For example, the external user defined process 218 can be invoked either before or after reading in the production job edit list or parent directory 240 to allow pre-processing of the edit list or parent directory before the pre-mastering process begins. It can be invoked again before creating the directory structure, during the creation of each branch of the directory tree, before each file in the edit list is read in, or during the creation/population of supplemental information, menus and configuration files. In addition, the external user defined process 218 can be invoked after the directory structure has been created and the last file or piece of supplemental information added and before the creation of the file system and selected format. The external user defined process 218 can be also be invoked during initialization of the file system creation 244 and while the assembled files and directory structure are written into the file system format. Finally, the external user defined process 218 can be invoked at the start of image file creation and afterwards.

It is noted that even though the present description relates to the client computer 202, client application 204, and/or production system 210 executing in a Microsoft Windows® Operating System environment, the various elements of embodiments of the present invention can be implemented in other operating system contexts, including, but not limited to, Apple Macintosh OS, Linux and Unix.

It is also noted that the software routines and drivers, such as various embodiments of the present invention, that operate computer based devices are often stored on machine-usable storage devices until they are read and executed. It is also noted that a variety of computer readable or machine-usable storage mediums are commonly utilized including, but not limited to, a non-volatile Flash memory, a ROM, an EEPROM, an application specific integrated circuit (ASIC), a magnetic media disk, a CD-ROM, a DVD, a hard drive, etc.

It is further noted that other production job, production system and pre-mastering embodiments of the present invention that allow back-end processing in the production system are possible and will be apparent for those skilled in the art with the benefit of this disclosure.

### CONCLUSION

A method and apparatus for back-end processing a recordable media production job after it has been generated and sent to a recordable media production system has been described that intercepts the image file generation at a low level within the recordable media production system and allows for adding, deletion and modification of the underlying data files and/or modification of the production job itself under control of an external user defined process, such as an application, DLL, script or plug-in. This interception of the image file generation occurs before the final image is assembled and handed off to the media recorder/producer to be written to the recordable media and is invoked at multiple stages of reading the production job edit list, allowing changes to occur at each stage of the imaging or pre-mastering process.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of modifying a production job in a recordable media production system, comprising:
processing a production job on a recordable media production system in preparation for writing a final image file of the production job to a selected recordable media; and
invoking an external user defined process at selected stages during processing the production job to allow modification of the production job.

2. The method of claim 1, further comprising receiving a production job at a recordable media production system, wherein the production job is one of an edit list, a list of files, a PowerImage, an image file, a track file and a parent production directory.

3. The method of claim 1, wherein processing the production job on the recordable media production system in preparation for writing a final image file of the production job to a selected recordable media further comprises processing the production job in an imager with a pre-mastering process to produce a final image file, where the external user defined process is invoked at specified points in the pre-mastering process by the imager.

4. The method of claim 1, further comprising writing the production job to one or more recordable media with a producer or recorder.

5. The method of claim 1, wherein the external user defined process is one of an application, a dynamically linked library (DLL), a script, a batch file or a plug-in.

6. The method of claim 1, wherein the recordable media is one of a magnetic media, an optical media, and a solid-state media.

7. The method of claim 6, wherein the recordable media is one of a floppy disk, a tape, a hard drive disk, a CD-ROM, a DVD, a Blue-Ray DVD, a Magneto-Optical disk, a Holographic disk, a Flash memory device and a PROM memory device.

8. The method of claim 1, wherein a format of production job for the recordable media is selected as one of FAT16, FAT24, FAT32, NTFS, ISO 9660, UDF, HFS, HFS+, Joliet, Rockridge, and UFS.

9. The method of claim 1, wherein the recordable media production system is one of an internal hardware and processes of a client computer having client software resident thereon to generate the production job, and a remote system coupled through a network to a client computer.

10. The method of claim 1, wherein the external user defined process is invoked by the recordable media production system by one of invocation of a statically assigned external process name, being passed into the production system as an argument, and being listed in a configuration file.

11. The method of claim 10, wherein two or more external user defined process are defined by being statically assigned external process names, being passed into the production system as an argument, or being listed in a configuration file and are invoked at each selected stage.

12. The method of claim 10, wherein the external user defined process is a stub process that sequentially invokes two or more second external user defined processes for each invocation or calling of the stub process.

13. The method of claim 10, wherein the external user defined process is not invoked if not present, passed in, or defined in a configuration file.

14. The method of claim 1, wherein the production system is in a suspended state while the external user defined process is executing.

15. The method of claim 1, wherein the external user defined process modifies, deletes or adds one of a directory, a file, and supplemental information to the production job.

16. The method of claim 15, wherein the external user defined process one of encrypts, watermarks, compresses, adds files, delete files, adds directories, deletes directories, changes a file name, changes a directory name, adds or changes archive data, add or changes media sourcing or specified recipient tracking data, adds or changes menu, sub-versions the production job, and adds a serial number or an ID to the production job.

17. The method of claim 1, wherein the production system passes a context to the external user defined process when it is invoked, where the arguments selected from one of the production job edit list name and location, the edit list line being processed, the file name, file size, and the file source and/or file destination directory being currently processed.

18. The method of claim 1, wherein the external user defined process passes back one of an edit list modification, a file source change, a file destination change, or a delete instruction to the production system when it returns.

19. A method of back-end processing during pre-mastering in a recordable media production system, comprising:
processing a production job on a recordable media production system in an imager pre-mastering process to produce a final image file of a selected recordable media; and
executing an external user defined process at specified points during pre-mastering process to allow back-end processing of the production job.

20. The method of claim 19, further comprising receiving a edit list of a recordable media production job at a recordable media production system, where the production job is one of a list of files, a PowerImage, an image file, a track file and a parent production directory.

21. The method of claim 19, wherein the external user defined process is one of an application, a dynamically linked library (DLL), a script, a batch file or a plug-in.

22. The method of claim 19, further comprising writing the production job with a producer to one or more recordable media, wherein the recordable media is one of a floppy disk, a tape, a hard drive disk, a CD-ROM, a DVD, a Blue-Ray DVD, a Magneto-Optical disk, a Holographic disk, a Flash memory device and a PROM memory device.

23. The method of claim 19, wherein the external user defined process is executed by one of invocation by the imager of a statically assigned external process name, being passed into the imager as an argument, and being listed in an imager configuration file.

24. The method of claim 19, wherein the external user defined process modifies, deletes or adds one of a directory, a file, and supplemental information to the edit list.

25. The method of claim 24, wherein the external user defined process one of encrypts, watermarks, compresses, adds files, delete files, adds directories, deletes directories, changes a file name, changes a directory name, adds or changes archive data, add or changes media sourcing or specified recipient tracking data, adds or changes menu, and adds a serial number or an ID to the edit list.

26. The method of claim 19, wherein the imager passes a context to the external user defined process when it is executed, where the arguments selected from one of the edit list name and location, the edit list line being processed, the file name, file size, and the file source and/or file destination directory being currently processed.

27. The method of claim 19, wherein the external user defined process passes back one of an edit list modification, a file source change, a file destination change, or a delete instruction to the imager when it returns.

28. A computer readable medium, the computer readable medium containing a software routine for causing a processor to execute a method of back-end processing during pre-mastering in a recordable media production system, wherein the method comprises:
receiving an edit list of a recordable media production job at a recordable media production system;
processing the production job on the recordable media production system in an imager pre-mastering process to produce a final image file of a selected recordable media, wherein an external user defined process is invoked at specified point during pre-mastering process to allow back-end processing of the production job; and
writing the production job with a producer to one or more recordable media.

29. A system, comprising:
a recordable media production system;
one or more client computers, each connectable to the production system to send a production job for a recordable media from a client software application to the production system,
wherein the recordable media production system is adapted to perform a method comprising:
processing a production job on the recordable media production system in preparation for writing a final image file of the production job to a selected recordable media, and
invoking an external user defined process is invoked at selected stages during processing the production job to allow modification of the production job.

30. The system of claim 29, wherein the recordable media production system is further adapted to receive a production job that is selected from one of an edit list, a list of files, a PowerImage, an image file, a track file and a parent production directory.

31. The system of claim 29, wherein the external user defined process is one of an application, a dynamically linked library (DLL), a script, a batch file or a plug-in.

32. The system of claim 29, wherein the recordable media production system is further adapted to write the production job to one or more recordable media, where the recordable media is one of a floppy disk, a tape, a hard drive disk, a CD-ROM, a DVD, a Blue-Ray DVD, a Magneto-Optical disk, a Holographic disk, a Flash memory device and a PROM memory device.

33. The system of claim 29, wherein the recordable media production system is further adapted to invoke the external user defined process by one of invocation of a statically assigned external process name, being passed into the production system as an argument, and being listed in a configuration file.

34. The system of claim 29, wherein the external user defined process modifies, deletes or adds one of a directory, a file, and supplemental information to the production job.

35. The system of claim 34, wherein the external user defined process one of encrypts, watermarks, compresses, adds files, delete files, adds directories, deletes directories, changes a file name, changes a directory name, adds or changes archive data, add or changes media sourcing or specified recipient tracking data, adds or changes menu, sub-versions the production job, and adds a serial number or an ID to the production job.

36. The system of claim 29, wherein the recordable media production system is further adapted to pass a context to the external user defined process when it is invoked, where the arguments selected from one of the production job edit list name and location, the edit list line being processed, the file name, file size, and the file source and/or file destination directory being currently processed.

37. The system of claim 29, wherein the recordable media production system is further adapted to receive a passed back argument from the external user defined process that is one of an edit list modification, a file source change, a file destination change, or a delete instruction to the production system when it returns.

38. A recordable media production system, comprising:
one or more recorders;
a computer; wherein the computer is connectable to a network and adapted to process and record a production job on a recordable media by:
receiving a recordable media production job at the recordable media production system;
processing the production job on the recordable media production system in an imager pre-mastering process to produce a final image file of a selected recordable media, wherein an external user defined process is invoked at specified point during pre-mastering process to allow back-end processing of the production job; and
writing the production job with the one or more recorders to one or more recordable media.
